(19) United States
(12) Patent Application Publication
(10) Pub. No.: US 2024/0354705 A1
(43) Pub. Date: Oct. 24, 2024

(54) MODERATED ACCESS TO SHARED RESOURCES ACROSS SEGMENT BOUNDARIES IN A SEGMENTED ENVIRONMENT

(71) Applicant: Microsoft Technology Licensing, LLC, Redmond, WA (US)

(72) Inventors: Abhijit Chandrashe PATHAK, Bangalore (IN); Vinay JAGANNATHA RAO, Bangalore (IN); Nivedita RAJANI, Bangalore (IN); Vladimir Vladimirovich GREBENIK, Redmond, WA (US); Li LI, Sammamish, WA (US); Nikita BANDYOPADHYAY, Bothell, WA (US); Seshadri MANI, Redmond, WA (US); Phani Vikram JUNGALI, Sammamish, WA (US); Arjit AGARWAL, Gorakhpur (IN)

(21) Appl. No.: 18/293,566

(22) PCT Filed: Jul. 22, 2022
(86) PCT No.: PCT/US2022/037954

§ 371 Date: Jan. 30, 2024

(30) Foreign Application Priority Data
Sep. 16, 2021 (IN) IN202141041950

(51) Int. Cl. G06Q 10/10

(52) U.S. Cl. CPC G06Q 10/103

(57) ABSTRACT

A computing system divides users into segments, each segment having a communication/collaboration policy that indicates how users assigned to the segment can communicate and collaborate with users of other segments. The users can be added to groups. Membership in the groups is controlled based on evaluation of the policies of the segments to which the users belong, a moderated group can have members that collaborate across segment boundaries.

### BACKGROUND

Computing systems are currently in wide use. Some computing systems are hosted systems which host services for tenants and users of tenants.

For example, some hosted computing systems allow users to form groups. Members of the groups can communicate with one another, such as through designated chat or text messaging channels or other mechanisms. Similarly, members of a group may be able to generate documents at a specific document management site and to collaborate on documents stored at that site.

Some current systems also implement information barriers that allow an administrative user to silo the users in an organization into multiple different segments and then create rules or policies that govern the communication between members of the different segments and that govern how the users of the different segments may access shared documents and collaborate on such documents. For example, in a tenant, it may be that the engineering department should not be in direct communication with the finance department, or be able to collaborate on documents with people in the human resources department. Therefore, the users in the engineering group may form one segment, the users in the finance group may form a second segment, and the users in the human resources group may form a third segment. The policies corresponding to each segment may prohibit communication and/or collaboration between users in one of those three segments with users in the other segments.

The discussion above is merely provided for general background information and is not intended to be used as an aid in determining the scope of the claimed subject matter.

### SUMMARY

A computing system divides users into segments, each segment having a communication/collaboration policy that indicates how users assigned to the segment can communicate and collaborate with users of other segments. The users can be added to groups. Membership in the groups is controlled based on evaluation of the policies of the segments to which the users belong. A moderated group can have members that collaborate across segment boundaries.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2A is a block diagram showing one example of a portion of a computing system in more detail.

FIG. 2B is a block diagram of a document management/collaboration system in more detail.

FIG. 2C is a block diagram of a group communication system in more detail.

FIG. 3 is a flow diagram illustrating one example of how user groups and segments are managed.

FIG. 4 is a flow diagram illustrating one example of the management of user membership in a group.

FIG. 5 is a block diagram of one example of a policy analysis system.

FIG. 6 is a flow diagram showing one example of the operation of a live path handler system.

FIG. 7 is a flow diagram showing one example of the operation of a retrospective path handler system.

FIG. 8 is a block diagram of a tenant architecture.

FIG. 9 is a block diagram of a tenant architecture.

FIG. 10 shows nested groups.

FIG. 11 is a block diagram showing one example of a computing system architecture in a cloud environment.

FIGS. 12-14 show examples of mobile devices that can be used in the architectures shown in the previous FIGS.

FIG. 15 is a block diagram of one example of a computing environment.

### DETAILED DESCRIPTION

As discussed above, host computing systems provide functionality that allows users to create groups of users. Such computing systems also may provide segmentation functionality that allow different segments of an organization to be precluded from communicating with and/or collaborating with one another. Users are assigned to different segments based upon user attributes (such as based upon the user's role, the department that the user belongs to, among other things). Each segment may have one or more policies that define how users assigned to that segment can communicate and collaborate with users assigned to other segments.

In many current systems, a user may belong to only a single segment. However, this can present problems. For instance, assume that the computing system is deployed across a plurality of 5000 different schools in a school district, with each school having a set of students and a set of teachers. It may be that students in one school should be precluded from talking to or collaborating with students in a different school. However, it may be that teachers should be able to talk to the students in their own school but also to teachers and staff in other schools in the same school district. Assume, therefore, the students and teachers in each school are assigned to a segment. Also assume that the policy generated for each segment is that only members of that segment can communicate and collaborate with one another. By assigning the students and teachers of a particular school to the same segment, this would allow the students and teachers to communicate with other students and teachers in that school. Therefore, this type of segmentation and policy generation accomplishes the desired intent for the students. However, this would also mean that the teachers at one school cannot communicate with the teachers at another school. Therefore, segmentation and policy generation is much more cumbersome for the teachers. Also, there may be some areas where users in different segments should be allowed to communicate with one another, even though users in the segments they are assigned to are not permitted to communicate or collaborate with one another.

The present description thus proceeds with respect to a system that allows a user to be assigned to multiple different segments. Therefore, a teacher can be assigned to a “school” segment that includes all of the teachers and students at a particular school. The teacher can also be assigned to an “all teachers” segment that contains the teachers and staff of all schools in the school district. In this way, the teachers can communicate and collaborate both with the students and teachers at their own school and with teachers at other schools. Similarly, the students can communicate and collaborate only with the teachers and students at their own school.

The present description also proceeds with respect to a system that allows users to be added to user groups, such as chat and collaboration groups. The system analyzes the policies corresponding to the different segments that the users belong to in order to control the membership of users in different groups to ensure that the policies of the various users in a group are consistent with one another so that no policies are violated. A policy may be generated for a segment. The policy applies to all users assigned to that segment. Therefore, when referring to a policy of a user, a policy corresponding to a user, a policy that applies to a user, a policy that governs a user, or similar terms, it is meant that the policy is for a segment to which the user has been assigned. By consistent it is meant, that the policies would not preclude one member of the group from communicating or collaborating with another member of the group. More specifically, policies that apply to a first user are consistent with policies that apply to a second user if the policies that apply to the first user do not indicate that the first user is precluded from collaborating or communicating with the second user. The policies that apply to the second user are consistent with the policies that apply to the first user if the policies that apply to the second user do not indicate that the second user is precluded from collaborating or communicating with the first user. By permitting moderated groups, the system reduces the memory resources needed because fewer and less complex policies are needed to permit desired collaboration and communication. The reduced number and complexity of policies thus also reduce the processor overhead needed to evaluate and apply such policies.

Further, the present description proceeds with respect to a system that supports moderated groups and controls membership and access to resources in such groups. Users who are members of a moderated group can communicate and collaborate across segment boundaries where communication and collaboration may be precluded by segment policies.

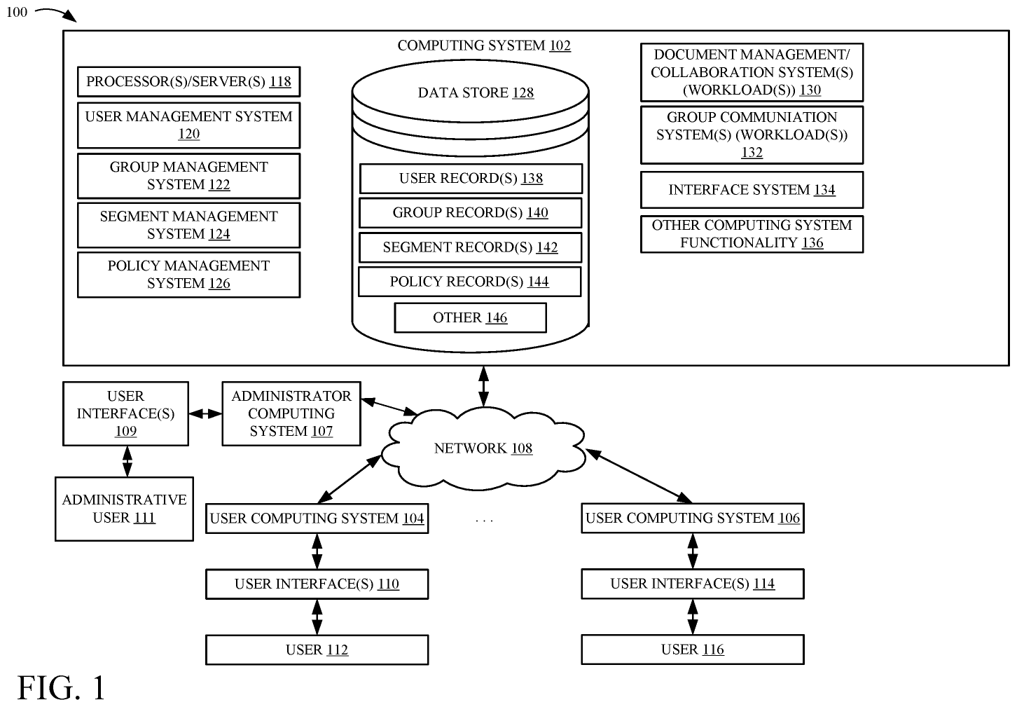

FIG. 1 is a block diagram of one example of a computing system architecture 100. Architecture 100 includes computing system 102 that can be accessed by a plurality of different user computing systems 104-106 and administrator computing system 107 over network 108. Network 108 can be a wide area network, a local area network, a near field communication network, a Wi-Fi network, a cellular network, or any of a wide variety of other networks or combinations of networks. In the example shown in FIG. 1 user computing system 104 is shown generating user interfaces 110 for interaction by user 112. FIG. 1 also shows that user computing system 106 can generate user interfaces 114 for interaction by user 116 and administrator computing system 107 can generate user interfaces 109 for interaction by administrative user 111. User 112 can interact with user interfaces 110 to control and manipulate user computing system 104 and some items of computing system 102. User 116 can interact with user interface 114 to control and manipulate user computing system 106 and certain portions of computing system 102. Administrative user 111 can interact with user interface 109 to control and manipulate administrator computing system 107 and some items in computing system 102.

Computing system 102, in the example shown in FIG. 1, can include one or more processors or servers 118, user management system 120, group management system 122, segment management system 124, policy management system 126, data store 128, document management/collaboration system(s) (or workload(s)) 130, group communication system(s) (or workload(s)) 132, user interface system 134, and other computing system functionality 136. Data store 128 can include user records 138, group records 140, segment records 142, policy records 144, and other items 146.

Computing system 102 hosts document management/collaboration system 130 that allows users in various groups to access and collaborate on documents maintained by document management/collaboration system(s) 130. Computing system 102 also hosts group communication system 130 which allow users in various groups to communicate with one another, such as through private chat messaging, or other group messaging or communications.

Interface system 134 illustratively exposes an interface that can be accessed by the user computing systems 104-106 in order to access the services hosted by computing system 102, such as the document management and collaboration services of system(s) 130 and the group communication services of system(s) 132.

User management system 120 can be used by administrative user 111 or other users to generate user records 138 that identify the various users 112-116 of the document management/collaboration system 130 and group communication system 132.

Group management system 122 illustratively allows users 112-116 to be added to groups. The groups are represented by group records 140.

Segment management system 124 allows segments to be generated so users 112-116 can be assigned to segments, and policy management system 126 allows policies to be generated and defined by administrative user 111 or other users for each of the segments generated by segment management system 124. The policies can define how users or groups that have been assigned to a particular segment can communicate and collaborate with other users or groups that are assigned to other segments.

When a group is generated by group management 122, then document management/collaboration system 130 may identify a particular site or location corresponding to that group where members of that group can generate, store and collaborate on different documents. Similarly, group communication system 132 can identify a communication channel such as a group chat or other channel where the members of the group can communicate with one another. Therefore, prior to adding a new user to a group, group management system 122 identifies the segments that the new user belongs to and the policies associated with those segments. The group management system 122 ensures that policies for segments to which the different users belong is consistent with one another before the new user is added to a group.

Document management/collaboration system 130 and group communication system 132 can be workloads (or applications) that control access to the documents and communication channels based upon the group membership. Therefore, document management/collaboration system 130 and group communication system 132 need not analyze the policies for each segment when granting access to documents or communication channels. Instead, systems 130 and 132 may simply access a group membership roster or list. If a user is part of a group that is authorized to access the documents or the communication channels, then that user is allowed access. If the user is not part of a group that is allowed access to a communication channel or set of documents, then that user is now allowed to access the documents or the communication channel. This relieves the burden of analyzing the various policies from document management/collaboration system 130 and group communication system 132. Instead, that analysis can be performed by group management system 122 as users are added to the different groups. The analysis thus needs to be done only once, when a user is added to a group, instead of every time a user wishes to access a document or a communication channel.

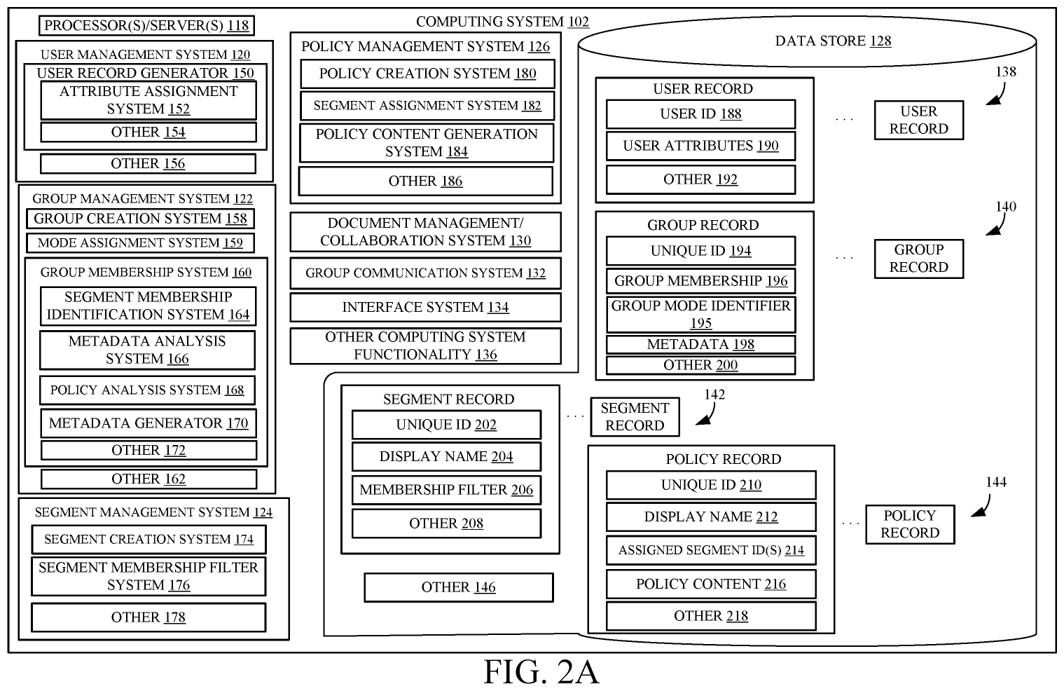

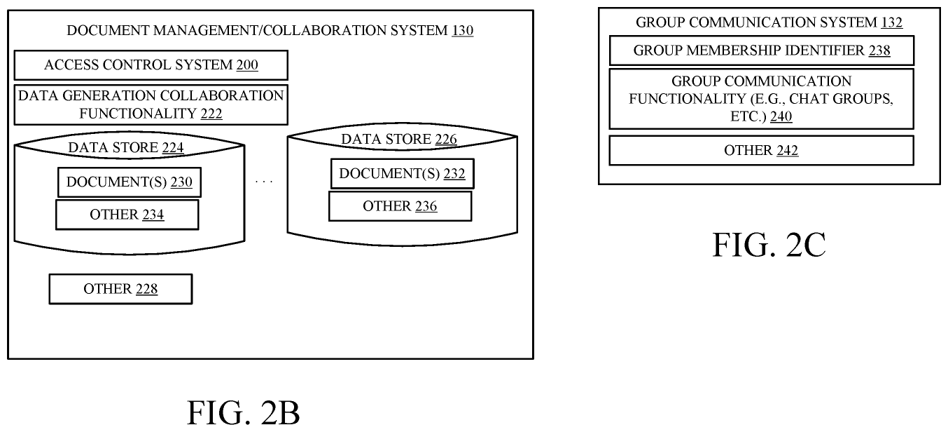

FIG. 2A is a block diagram of computing system 102 showing various items of computing system 102 in more detail. FIG. 2B is a block diagram showing one example of document management/collaboration system 130 in more detail, and FIG. 2C is a block diagram showing one example of group communication system 132 in more detail. FIGS. 2A, 2B, and 2C will now be described in conjunction with one another. Some of the items shown in FIGS. 2A-2C are similar to those shown in FIG. 1, and they are similarly numbered. FIG. 2A shows that user management system 120 illustratively includes user record generator 150 which, itself, includes attribute assignment system 152 and other items 154. User management system 120 can also include other items 156. FIG. 2A also shows that group management system 122 can include group creation system 158 (which can include mode assignment system 159 and other items 161), group membership system 160, and other items 162. Group membership system 160 can include segment membership identification system 164, metadata analysis system 166, policy analysis system 168, metadata generator 170, and other items 172. FIG. 2A also shows that segment management system 174 can include segment creation system 174, segment membership filter system 176, and other items 178. Policy management system 126 can include policy creation system 180, segment assignment system 182, policy content generation system 184, and other items 186.

FIG. 2A shows that each of the user records 138 can include a user identifier (ID) 188, user attributes 190, and other items 192. Each of the group records 140 can include a unique ID 194, group mode identifier 195, group membership 196, metadata 198, and other items 200. Each of the segment records 142 can include unique ID 202, display name 204, membership filter 206, and other items 208. Each of the policy records 144 can include unique ID 210, display name 212, assigned segment IDs 214, policy content 216, and other items 218.

Data management/collaboration system 130 can include access control system 220, data generation/collaboration functionality 222, a plurality of data stores 224-226, and other items 228. Each data store 224-226 can include documents 230, 232 and other items 234, 236. Group communication system 132 can include group membership identifier 238, group communication functionality 240, and other items 242.

User record generator 150 can be used by a user or administrator to assign attributes to different users. The attributes may include a user identifier, a user name, a user role, etc. For each user, a user record 138 is created. The user record shown in FIG. 2A includes a user ID 188, a set of user attributes 190, and other items 192.

Group management system 122 can be used to generate and manage groups. Membership in different groups can be used to control user access to different documents, and to control user communication with various groups of users. Group creation system 158 can be used to create a group record 140 for a particular group. The group record can include a unique identifier 194, a group mode identifier 195 (that may be used to identify whether the group is a moderated group), a list of users in the group (or group membership) 196, and a set of metadata identifying the different users, the segments to which those users belong, and other information about users in a particular group. Some examples of metadata 198 are described in greater detail below. Group membership system 160 controls the membership in the group. Segment membership identification system 164 identifies the segments that each member of the group belongs to. Metadata analysis system 166 identifies policies corresponding to the segments to which the different users (who are members or are to be added as a member of the group) belong to determine whether the policies are consistent based on the metadata, without analyzing the policies. Policy analysis system 168 identifies the various policies for the segments to which the group members belong to ensure that the policies are consistent with one another and to identify whether users can be added to a moderated group, if this cannot be determined based on the metadata. Metadata generator 170 generates or updates the metadata 198 for a particular group as members are added to or deleted from the group.

Segment management system 124 can be used to generate segments and manage the membership of users in those segments. Segment creation system 174 can be used to create a segment record 142 that may have a unique ID 202 and a segment name 204. Segment membership filter system 156 can be used to generate a membership filter 206 that defines who is assigned to the particular segment represented by the particular segment record 142. The segment membership filter 206 may describe, for instance, attributes of users that are assigned to the segment, group identifiers that identify groups that are assigned to the segment, among other things. By applying the membership filter 206 to the various user records 138 and group records 140, the membership filter 206 can be used to identify the different users and groups that are assigned to each segment. It will be noted that a separate membership roster can also be maintained for each segment so that the membership filter 206 need not be applied as frequently.

Policy creation system 180 allows a user or administrator to create policies that are then assigned to the different segments. The policies are illustratively used to control how members of a particular segment can collaborate, communicate, and otherwise interact with other users who are members of the same segment and of other segments. Policy creation system 180 allows the administrator or user to generate a policy record 144 which may include a unique identifier 210 for a policy and a display name 212 for the policy. Segment assignment system 182 allows segments to be assigned to the policy. Thus, assigned segment identifiers 214 identify the various unique IDs 202 of segments that are assigned to the policy corresponding to the policy record. Policy content generation system 184 then allows the user or administrator to generate the content of the policy. The content of the policy may identify how users in segments who are assigned to this policy can interact with users in the same or other segments. For instance, a policy may indicate that members of a segment may communicate and collaborate with one another. In addition, the policy may indicate that members of a first segment may interact with and collaborate with members of a second segment but not with members of a third segment.

Data generation/collaboration functionality 222 may assign a particular location or site (e.g., represented by data store 224) where documents 230 can be stored for access by a particular group or set of groups. Similarly, data generation/collaboration functionality 222 may identify a second site (such a data store 226) where the documents 232 may be accessed by a second group or set of groups. Access control system 220 controls access to the documents at the different sites in data stores 224-226 based upon the membership of the various users attempting to access those documents in the groups to which the sites are assigned. For instance, if a first group is assigned a location in data store 224 where that group documents 230 are to be stored so they can be accessed by members of the group, then access control system 220 identifies whether a user who is attempting to access the documents 230 is a member of that group and if so, access is granted. If not, access is denied.

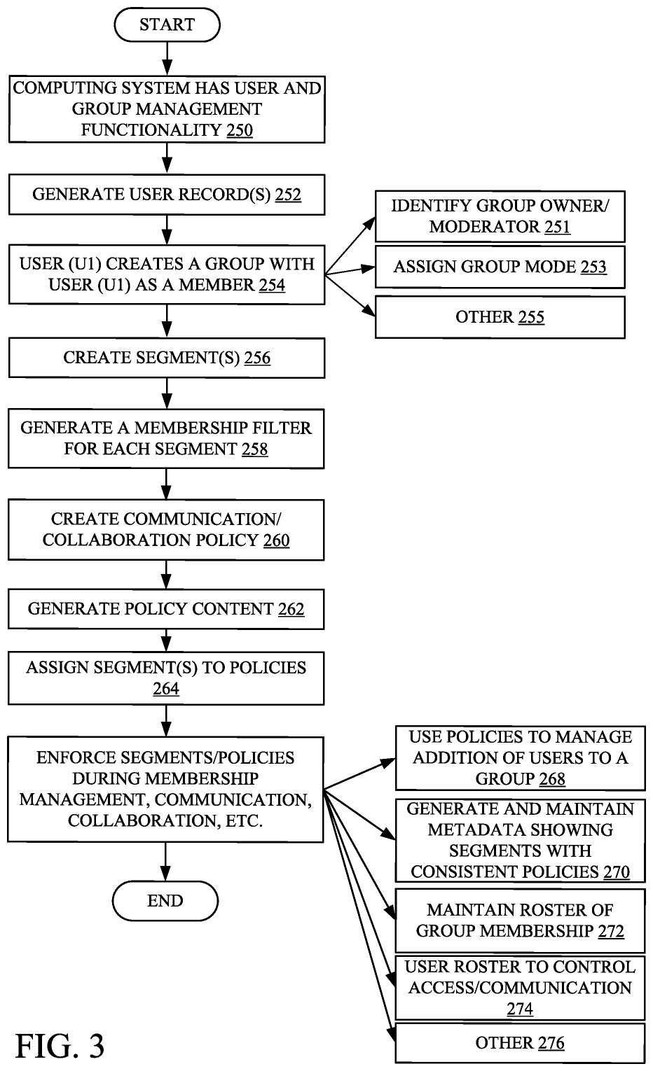

FIG. 3 is a flow diagram illustrating one example of the operation of computing system 102 generating user records 138, group records 140, segment records 142, and policy records 144, and enforcing the segments and policies. It is first assumed that computing system 102 has user and group management functionality such as user management system 120 and group management system 122. Providing a computing system 102 with such functionality is indicated by block 250 in the flow diagram of FIG. 3. At some point, interface system 134 exposes an interface so that a user 112-116 or an administrative user 111 can generate user records 138 for a plurality of different users. Generating the user records is indicated by block 252 in the flow diagram of FIG. 3.

It is next assumed that a user 112 (labeled U1 in FIG. 3) creates a group with user U1 as a member of the group. By way of example, group creation system 158 can receive inputs through an interface exposed by interface system 134 from a user and, in response to those inputs, generate a group record 140 creating a group. Initially, the group may have only a single member which is user U1 who is also the owner of the group. Creating a group with user U1 as a member is indicated by block 254 in the flow diagram of FIG. 3. The creator of the group may also identify the group as a moderated group with user U1 as the moderator, as indicated by block 251. Mode assignment system 159 also assigns the group mode. It may be a moderated mode or an unmoderated mode or a different mode. Assigning the group mode is indicated by block 253 and may be done in other ways, as indicated by block 255.

At some point, segment creation system 174 receives inputs to create a segment, as indicated by block 256. The input may again be received through an interface exposed by interface system 134 and, in response, a segment record 142 is created to represent the segment. Segment membership filter system 176 then receives inputs to generate a membership filter for the segment that has been created. The membership filter is stored as filter 206 in the corresponding segment record. Generating a membership filter for each segment is indicated by block 258 in the flow diagram of FIG. 3. The membership filter 206 may define user attributes, or groups, or other information that can be used to determine whether a user or group is a member of the segment corresponding to the membership filter 206.

Policy management system 126 then receives inputs to generate a policy record 144 corresponding to a communication/collaboration policy that can be assigned to different segments. Creating the communication/collaboration policy is indicated by block 260 in the flow diagram of FIG. 3. Policy content generation system 184 then receives inputs to generate the policy content which can be applied to control how members of different segments can communicate and collaborate with one another. Generating the policy content is indicated by block 262 in the flow diagram of FIG. 3. Segment assignment system 182 then receives inputs assigning segments to the various policies (or assigning the policies to the different segments). Assigning segments and policies to one another is indicated by block 264 in the flow diagram of FIG. 3.

With each of the segments now having a membership filter so that membership in the segments can be determined, and having policies assigned to them, the segments can be used to enforce the policies that govern communication and collaboration among the various users in those segments. The segments and policies can be used by group management system 122 to determine which users can be parts of which groups, based upon the policies for the segments to which the users and groups belong. Enforcing the segments and policies during membership management, communication, and collaboration, etc. is indicated by block 266 in the flow diagram of FIG. 3. For instance, group membership system 160 can use the policies to manage the addition of users to groups, as indicated by block 268. Metadata generator 170 can generate and maintain metadata showing the segments that are represented by members in a particular group and thus indicating which policies for those segments have been evaluated to be consistent with one another, as indicated by block 270. Group membership system 160 may also maintain a roster of membership in the various groups. The roster may identify the users, the segments that those users belong to, the other groups that the users belong to, among other things. Maintaining a roster of group membership is indicated by block 272 in the flow diagram of FIG. 3. Document management/collaboration system 130 and group communication system 132 can then govern whether users can access various documents and communicate with one another based upon the membership in the various groups, as shown in the roster. This is indicated by block 274 in the flow diagram of FIG. 3.

In this way, systems 130 and 132 only need to access the group membership to determine whether users can collaborate with one another and communicate with one another. Systems 130 and 132 need not analyze the policies, as this is done in controlling group membership. The segments and policies can be enforced in other ways as well, as indicated by block 276.

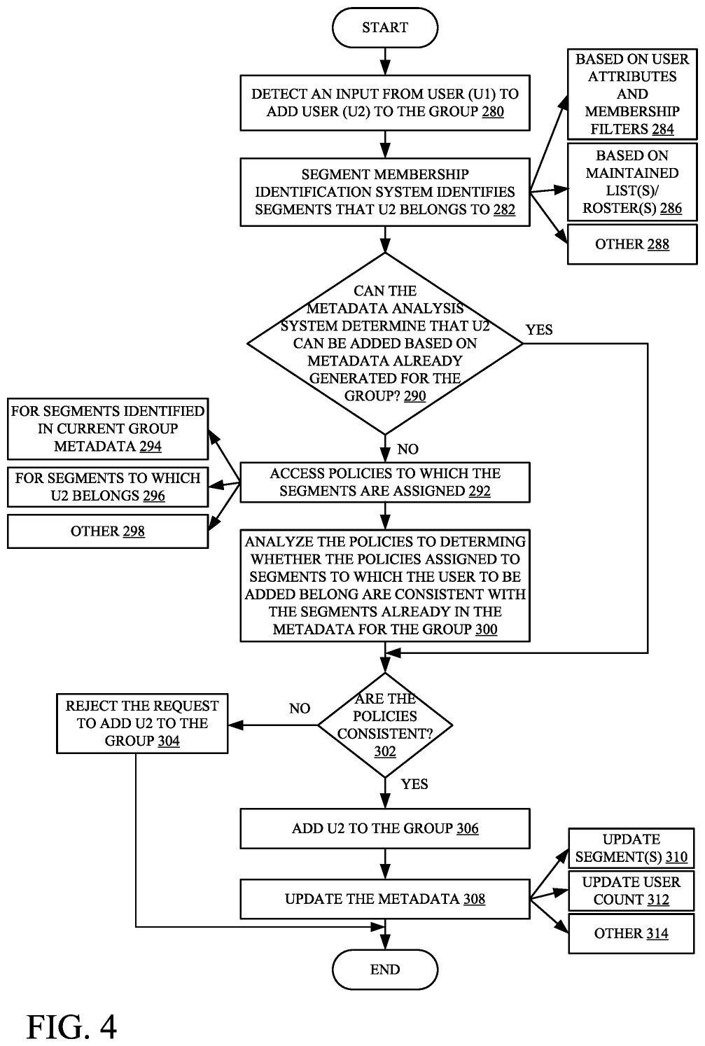

FIG. 4 is a flow diagram illustrating one example of the operation of computing system 102 in enforcing the policies and segments in adding membership to various unmoderated groups. Assume first that a set of users U1-U6 are considered for membership in a group. For purposes of the present example, assume that user U1 belongs to segment A, user U2 belongs to both segments A and B, user U3 also belongs to segment A, user U4 also belongs to segments A and B, user U5 belongs to segment D and user U6 belongs to segments A, B and C. Also, assume also that the policies for segments A and B indicate that the users in segments A and B can communicate and collaborate with one another and with the other users in segments A and B. Assume that the policy for segment C indicates that users that are in segment C can communicate with one another and with users in segments A and B. Table 1 shows events that are performed in accordance with the present example. The first column in Table 1 represents events that are taken. The second column represents the group membership after the event in column 1 is taken, and the third column represents the group metadata that is generated for the group after the event is taken.

TABLE 1

| | GROUP | |
|---|---|---|
| EVENT | MEMBERSHIP | GROUP METADATA |
| U1 CREATES | U1 | {A:1} |
| GROUP | | |
| U1 ADDS U2 | U1, U2 | {{A:1}, {(A, B):1}} |
| U1 ADDS U3 | U1, U2, U3 | {{A:2}, {(A, B)}:1}} |
| U1 ADDS U4 | U1, U2, U3, U4 | {{A:2}, {(A, B)}:2}} |
| U2 ADDS U6 | U1, U2, U3, U4, U6 | {{A:2}, {(A, B):2}, |
| | | {(A, B, C):1}} |

In accordance with the present example, user U1 creates a group and is the only member of the group. Metadata generator 170 generates metadata {A:1} which has a segment indicator A and a user count indicator 1. Thus, the metadata {A:1} indicates that the group has one member who is assigned to segment A.

Now, assume that user U1 wishes to add a user U2 to the group. User U1 thus provides an input through an interface to group membership system 160 to add user U2. Detecting an input from user U1 to add user U2 to the group is indicated by block 280 in the flow diagram of FIG. 4. Segment membership identification system 164 then identifies the segments that user U2 belongs to, as indicated by block 282. Segment membership identification system 164 can apply the membership filters of the various segments to the user attributes for user U2 or consult a roster that indicates the membership in each segment or access a user attribute for user U2 that identifies the segments user U2 belongs to. Identifying the segments that user U2 belongs to based upon the user attributes and/or membership filters is indicated by block 284. Identifying the segments that user U2 belongs to based upon a list or roster is indicated by block 286. Segment membership identification system 164 can identify the segments that user U2 belongs to in other ways as well, as indicated by block 288. Thus, at block 282 it is determined that user U2 belongs to segments A and B.

Metadata analysis system 166 then accesses the metadata (metadata {{A:1}}) to determine whether system 166 can identify whether the policy for the segments that user U2 belongs to are consistent with the policies in segment A without actually analyzing the policies. It can be seen that the metadata for the group ({A:1}) does not reflect that any analysis has been done with respect to segment B. Therefore, the answer at block 290 in FIG. 4 is no.

Policy analysis system 168 then accesses the policies for segment A and the policies for segment B to determine whether they are consistent with one another so that user U2 can be added to the group without violating any of the policies. By way of example, if the policy for segment B indicates that the users that belong to segment B cannot communicate with the users in segment A, this would be inconsistent so that user U1 would not be allowed to add user U2 to the group. However, assuming that the policies in segment A allow users in that segment to communicate and collaborate with the users in segment B, then the policies are consistent and user U2 can be added. Accessing the policies corresponding to the segments is indicated by block 292 in the flow diagram of FIG. 4. The policies that are accessed are those policies for the segments identified in the current group metadata ({A:1}), as indicated by block 294. For instance, the group metadata shows that segment A is represented in the group so the policies for segment A are accessed. In addition, the policies accessed are those policies for segments to which user U2 belongs, and thus would also include the policies for segment B (since user U2 belongs to both segments A and B), as indicated by block 296. The policies can be accessed in other ways as well, as indicated by block 298.

Policy analysis system 168 analyzes the policies to determine whether the polices assigned to segments to which the user to be added U2 belongs are consistent with the segments already in the metadata (segment A) for the group. Therefore, in the present example, policy analysis system 168 analyzes the policies for segments A and B to determine whether they are consistent. Analyzing the policies is indicated by block 300.

If the policies are not consistent, as indicated by block 302, the request to add user U2 to the group is rejected, as indicated by block 304. However, if, at block 302, policy analysis system 168 determines that the policies are consistent with one another, then group membership system 160 adds user U2 to the group, as indicated by block 306. The metadata 198 corresponding to the group is then updated, as indicated by block 308. The segments represented in the group metadata are updated as indicated by block 310, the user count corresponding to those segments in the metadata is also updated as indicated by block 312, and the metadata can be updated in other ways as well, as indicated by block 314.

As seen in the second row of Table 1, the metadata has now been updated to show not only that one user in the group belongs to segment A but another user in the group also belongs to segments A and B. Thus, the metadata is as follows: {{A:1}, {(A, B):1}}.

The present discussion will now proceed with respect to a number of additional examples that are reflected in Table 1 for the sake of illustration. It can now be seen in Table 1 that the membership in the group consists of users U1 and U2. Also, the metadata shows that one user in the group belongs to segment A and one user in the group belongs to segments A and B.

Now, assume that user U1 attempts to add user U3 to the group, and that U3 belongs to only segment A. Segment membership identification system 164 identifies that user U3 only belongs to segment A. Metadata analysis system 166 can then determine that user U3 can be added to the group simply by looking at the metadata that already exists. It can be seen by the metadata that a user is already in the group that belongs only to segment A (based on the metadata {A:1}). Therefore, user U3 can be added without analyzing any further policies. Thus, the third row in Table 1 shows that user U1 adds user U3 so that the group membership consists of users U1, U2, and U3. The metadata generator 170 also updates the metadata to show that two members of the group belong to only segment A and one member of the group belongs to both segments A and B so that the metadata is as follows: {{A:2}, {(A,B):1}}.

Now assume that user U1 wishes to add user U4 to the group and that user U4 is a member of segments A and B. Again, since a user in the group is already a member of segments A and B, metadata analysis system 166 can determine that user U4 can be added to the group simply by analyzing the metadata. Therefore, row four in Table 1 shows that U1 adds user U4. Therefore, the group membership now consists of U1, U2, U3, and U4. Metadata generator 170 then updates the metadata to show that the group now contains two users that belong to segments A and B as follows: {{A:2}, {(A, B): 2}}.

Now assume that user U5 attempts to access documents in document management/collaboration system 130 that are accessible by members of the group. Assume that user U5 is a member of segment A. User U5 still cannot access the documents corresponding to the group because access control system 220 determines that user U5 is not a member of the group. The group membership 196 in the group record only includes users U1, U2, U3, and U4. Based on that group membership, access control system 220 denies user U5 access to the documents.

Now, assume that user U2 attempts to add user U6 to the group and that user U6 is a member of segments A, B, and C. Assume that the policy for segment C and the policy for segments A and B indicate that members of the three segments can communicate and collaborate with one another. Therefore, policy analysis system 168 determines that the policies are consistent and that U6 can be added to the group. Metadata generator 170 then updates the metadata to reflect this. Thus, the last line in Table 1 shows that after user U2 adds user U6 to the group, the group membership is reflected as U1, U2, U3, U4, and U6. Also, the metadata for the group is updated to indicate that there is a member of the group that belongs to segments A, B, and C. Therefore, the metadata is updated as follows:
{{A:2}, {(A,B): 2}, {(A,B,C):1}}.

Assume now that user U2 attempts to add user U7 to the group and user U7 is a member of segment D. Assume further that the policy for segment D indicates that members of segment D cannot communicate or collaborate with members of segment B. In that case policy analysis system determines that the policy for segment D is not consistent with the policies in the other segments represented by members of the group. Therefore, the request to add user U7 is denied.

It can thus be seen that the present system allows a user to be added to multiple different segments. In addition, membership in various groups is managed based upon the policies for the segments to which the various users belong. However, access and collaboration on documents, as well as communication, is controlled based upon the group membership so that only the group management system needs to analyze the policy segments for consistency when adding members to a group. The document management/collaboration system and group communication system need only access the group membership to see whether members of the groups can collaborate and communicate with one another.

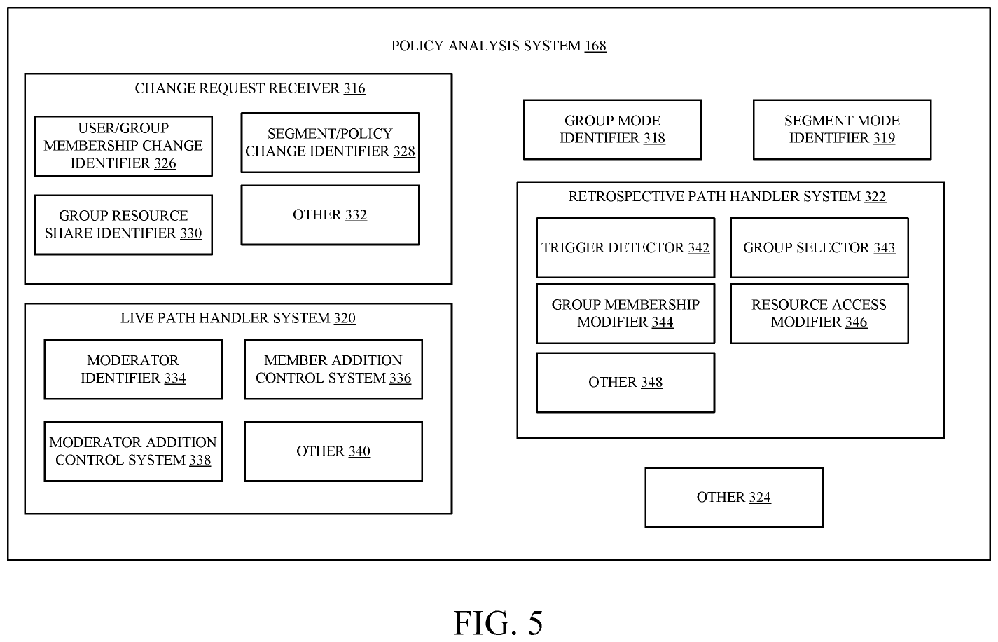

FIG. 5 is a block diagram showing one example of policy analysis system 168 in more detail. System 168 will be described with respect to controlling the addition of members to groups and controlling access to resources of a group in situations in which the group is a moderated group. System 168 illustratively includes change request receiver 316, group mode identifier 318, segment mode identifier 319, live path handler system 320, retrospective path handler system 322, and it can include other items 324 as well.

Change request receiver 316 illustratively includes user/group membership change identifier 326, segment/policy change identifier 328, group resource share identifier 330, and other items 332. Live path handler system 320 includes moderator identifier 334, member addition control system 336, moderator addition control system 338, and other items 340. Retrospective path handler system 322 can include trigger detector 342, group selector 343, group membership modifier 344, resource access modifier 346, and other items 348. Before describing the overall operation of policy analysis system 168 in more detail, a description of some of the items in system 168, and their operation, will first be provided.

Change request receiver 316 receives notification that a change has been made at a workload, to the segmentation at the workload, or to a policy. Change request receiver 316 can also receive change requests which indicate that a user record has changed or that a change to membership in a group has been requested by a workload. The change can be a change to a user record, group record, segment record, and/or policy record. User/group membership change identifier 326 analyzes the notification to identify whether the request is to change a user record 138 or group membership record 140. Segment/policy change identifier 328 analyzes the notification to determine whether the request is to change a segment record 142 or policy record 144. Change request receiver 316 generates an output indicating that a change has been made to a segment or policy, to a user record, or that a group membership change was requested.

Group resource share identifier 330 receives a notification that a member of a group is attempting to share resources (e.g., documents, emails, etc.) on the group site. By way of example, change request receiver 316 may receive a request to add a new member to a group, to add a member as a moderator of a group, or a notification of a change to a segmentation or a policy corresponding to a segment or group.

When the request is to change the membership in a group (e.g., to add a member, a moderator, etc.), group mode identifier 318 then identifies the group mode corresponding to the group to which a member or moderator is to be added. For instance, the group mode may indicate that the group is a moderated group or a non-moderated group.

Live path handler system 320 receives the output of change request receiver 316 indicating the request. The output from system 320 may indicate that the change request is to add a member to a group either as a moderator or as a non-moderator member of the group. Live path handler system 320 generates an output indicative of whether a proposed user can be added to a group either as a member or as a moderator. In doing so, system 320 may analyze whether the member to be added is governed by policies that are consistent with those of a current moderator of the group. Therefore, moderator identifier 334 identifies a current moderator (or moderators) of the group to which a proposed user is to be added. Member addition control system 336 analyzes the policies and segments corresponding to the group and determines whether the proposed user can be added as a member. Moderator addition control system 338 determines whether the proposed user can be added as a moderator.

Also it may be that a member may be deleted from a group at a workload, or the role of a user may change, or segmentation of a tenant may change, or policies for a tenant may be revised. Therefore, retrospective path handler system 322, when triggered, analyzes the membership in the groups to determine whether the current membership is still consistent with the policies and segmentation of the tenants. Trigger detector 342 detects a trigger indicating that it is time for retrospective path handler system 322 to run and to perform this type of analysis. Group membership modifier 344 identifies members in groups that are now inconsistent with the policies and/or segmentation of the tenant and thus modifies the membership of the group based on the inconsistencies. Resource access modifier 346 determines when access to resources of a group is to be modified (e.g., removed or restricted) based upon changes to the group membership.

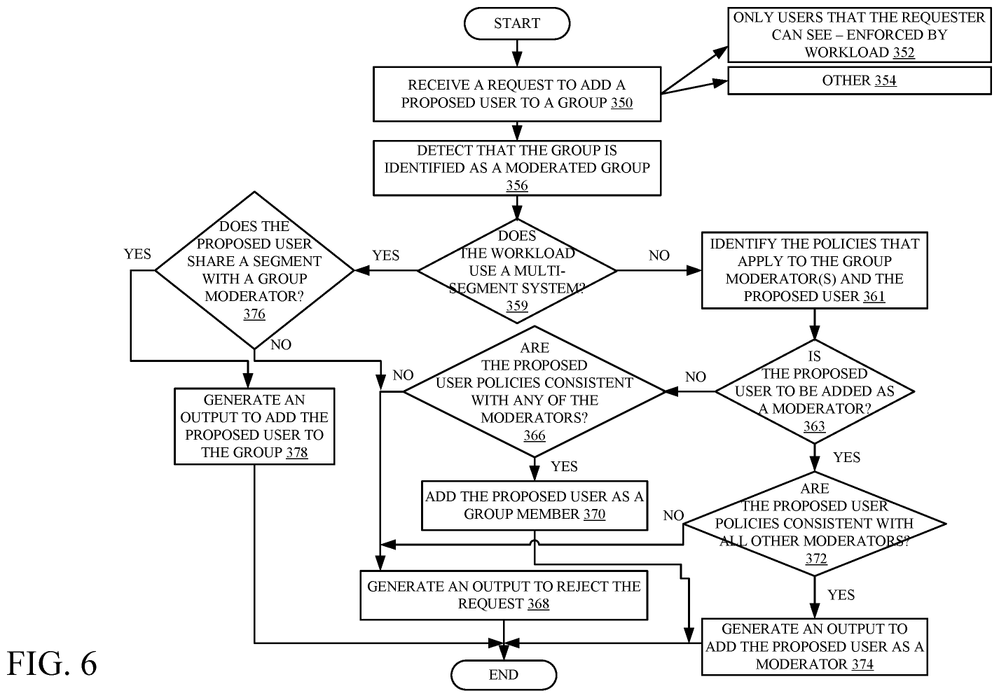

FIG. 6 is a flow diagram illustrating one example of the operation of policy analysis system 168 in receiving a request to add a user to a group, and in using live path handler system 320 to generate an output indicating whether the user can be added to the group, based upon the current group membership, tenant segmentation, tenant policies, etc.

It is first assumed that one of the workloads 130, 132 provides a request to add a proposed user to a group within the workload. The user/group membership change identifier 326 identifies the request as a request to add a user to a group. The group may be a chat group, a meeting group, a group of users that have access to a collaboration site, or another group. Receiving the request to add a proposed member to a group is indicated by block 350 in the flow diagram of FIG. 6. In one example, the workloads control the interface for adding a user to a group so that only users that the requestor has authority to add will be shown to the user, as indicated by block 352. The request to add a proposed user to a group can be received in other ways as well, as indicated by block 354. Group mode identifier 318 then identifies that the group to which the proposed user will be added is a moderated group meaning that it has one or more moderators. Detecting that the identified group is a moderated group is indicated by block 356 in the flow diagram of FIG. 6.

Segment mode identifier 319 then determines whether the workload uses a multi-segment system in which a user can be assigned to multiple different segments, as discussed above. Determining whether the workload uses a multi-segment system is indicated by block 319 in the flow diagram of FIG. 6.

Moderator identifier 334 identifies the moderator for the group and policy analysis system 168 then identifies the policies that apply to the group moderators and the proposed user. Identifying the policies that apply to the group moderator and the proposed user is indicated by block 361. Moderator addition control system 338 then determines whether the proposed user is being added as a moderator for the group as indicated by block 363. If at block 363 the proposed user is not to be added as a moderator, then member addition control system 336 controls the addition of the member to the group.

Member addition control system 336 determines whether the proposed user policies are consistent with the policies governing any of the moderators of the group, at block 366. If the proposed user is governed by policies that are not consistent with the policies governing at least one of the moderators, then member addition control system 336 generates an output indicating that the request to add the proposed user to the group should be rejected, as indicated by block 368. The output can take different forms. The output can be a notification to the workload that is proposing that the user be added to the group. The output can be a control signal or command that controls the workload to add the user to the group. The output can be a response to the received request. On the output can be a different output. If, at block 366, member addition control system 336 determines that the proposed user is governed by policies that are consistent with those governing at least one of the moderators of the group, then member addition control system 320 generates an output indicating that the proposed user may be added as a member of the group, as indicated by block 370.

Now assume that, at block 363, it is determined that the request to add the proposed user is requesting that the proposed user be added as a moderator of the group. Then, moderator addition control system 338 controls whether the proposed user will be added as a moderator to the group. Moderator addition control system 336 analyzes the policies that govern the proposed user all of and the policies that govern the other moderators of the group to determine whether those policies are consistent. If the policies that govern the proposed user are not consistent with all of the policies that govern the other moderators of the group, then the moderator addition control system 338 generates an output indicating that the request to add the proposed user as a moderator of the group should be rejected, as indicated by block 368. Determining whether the policies are consistent is indicated by block 372 in the flow diagram of FIG. 6. If, at block 372, moderator addition control system 338 determines that the policies governing the proposed user are indeed consistent with all of the policies governing the other moderators of the group, then moderator addition control system 338 generates an output indicating that the proposed user should be added as a moderator to the group, as indicated by block 374 in the flow diagram of FIG. 6. As discussed above, the output can take different forms. It can be a notification, a control or command signal, a response to the request, or another output.

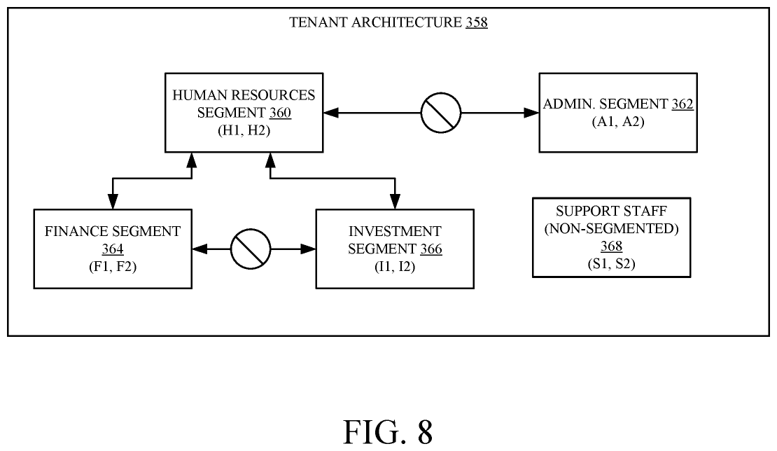

FIG. 8, shows an example of a tenant architecture 358 that is a segmented architecture, but that does not use a multi-segment system. Thus, each user in architecture 358 is assigned to only one segment. In tenant architecture 358, human resources segment 360 has two members, users H1 and H2. Administrator segment 362 has two members, users A1 and A2. Finance segment 364 has two members, users F1 and F2, and investment segment 366 has two members, users I1 and I2. Tenant architecture 358 also has a set of non-segmented members such as support staff 368 that has members S1 and S2. Assume that the segments 364 and 366 have policies indicating that the members of those segments are not to communicate or collaborate with one another. Assume also that segments 360 and 362 have policies indicating that members of those segments should not collaborate or communicate with one another.

The following description of FIG. 8 shows an example of how policy analysis system 168 controls membership in a group that has been designated as a moderated group. Assume, for instance, that user H1 creates a group in a workload 130-132 and is designated as the moderator of the group. Assume that H1 requests to add user F1 to the group. Moderator identifier 334 identifies H1 as the moderator of the group and member condition control system 336 analyzes the policies governing using H1 and F1. Because the policies governing H1 and F1 are consistent with one another, the user F1 is added to the group. Assume also that user H1 wishes to add user I1 as a member of the group. I1 will be added to the group because the policies governing I1 and H1 are compatible with one another. It can thus be seen that the group formed by H1 now allows users I1 and F1 to communicate and collaborate with one another, even though they are in segments 364 and 366 where collaboration and communication is prohibited by policies. Because the group is a moderated group and both users F1 and I1 have policies that are consistent with those of the moderator H1 of the group, the group can be formed.

Now assume that user H1 requests to add user I2 as a moderator of the group. Because H1 is the only moderator of the group at the current time, then moderator addition control system 338 analyzes the policies that govern users H1 and I2 to determine whether they are consistent with one another. Because they are consistent with one another, user I2 can be added as a moderator of the group along with user H1.

Next assume that moderator H1 requests to add user A1 as a moderator of the group. Moderator addition control system 338 determines whether the policies governing users A1 and H1 are compatible with one another. Because they are not, moderator addition control system 338 generates an output indicating that the request to add user A1 as a moderator of the group should be rejected.

It should also be noted that, in one example, only the moderators of a group can share group resources. For instance, moderator H1 may create and a share a link, share documents that are available on a document sharing and collaboration site, or other resources. However, user F1 cannot create and share a link or create and share documents on a document collaboration site. Similarly, in a scenario in which the group is used in a meeting system, then the moderator controls who can join a meeting and start the meeting and use other functionality, such as recording the meeting. Similarly, the moderator may set policies in a group chat to govern subject matter and other information that can be offered on the group chat.

Also, in one example, non-segmented users may be added as a moderator or member of a group. For instance, assume that user H1 requests to add user S1 as a moderator or member of the group. Control system 336 or 338 will generate an output indicating that the user S1 can be added as the moderator or member of the group.

Also, in one example, live path handler system 320 generates an output notifying retrospective path handler system 332 when requests are received to add or remove users from a group. This enables retrospective path handler system 322 to retrospectively modify the group membership so that appropriate policies can be analyzed when controlling group membership in the future.

Returning again to FIG. 6, if, at block 359, segment mode identifier 319 indicates that the workload does use a multi-segment system, then live path handler system 320 determines whether the proposed user shares a segment (e.g., is assigned to a common segment) as one of the moderators of the group, as indicated by block 376. Identifying the segments to which a user belongs can be done by analyzing the metadata as discussed above with respect to FIG. 4 and Table 1, or in other ways. If the proposed user does share a segment with one of the group moderators, then live path handler system 320 generates an output indicating that the proposed user should be added to the group either as a member or as a moderator, as requested. Generating an output to add the proposed user to the group is indicated by block 378 in the flow diagram of FIG. 6. As discussed above, the output can be a notification to the requesting workload, a command or control signal, a response to the request, or another output.

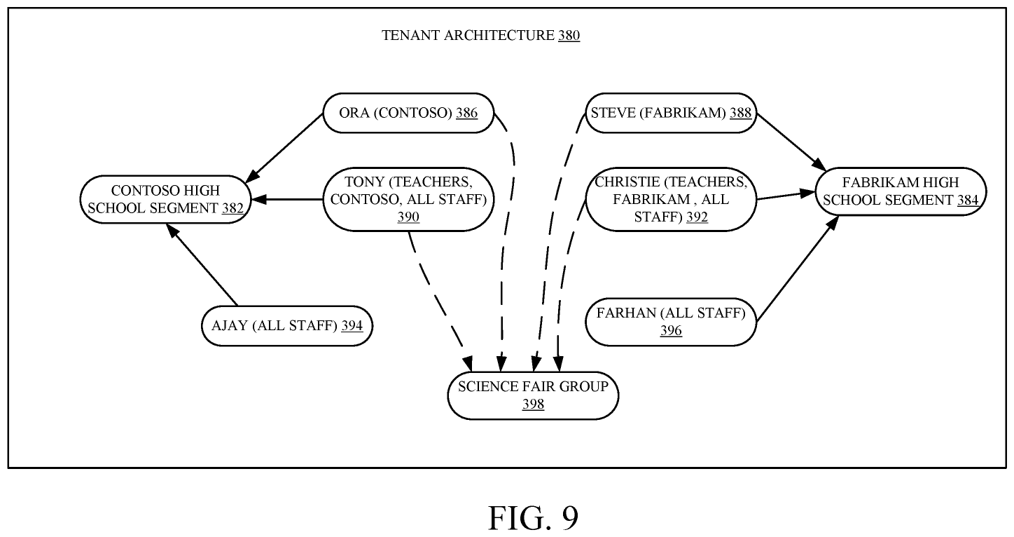

FIG. 9 shows another example of a tenant architecture 380. In the example shown in FIG. 9, there are two different high school, computing systems that are assigned to assigned to two separate segments Contoso High School segment 382 and Fabrikam High School segment 384. Each of the high schools have teachers and students all assigned to a common segment Contoso High School students and teachers are assigned to the Contoso High School segment 382 and the Fabrikam High School students and teachers are assigned to the Fabrikam High School segment 384. Two different students Ora 386 and Steve 388 are assigned to their corresponding high school segments. Therefore, Ora 386 is assigned to the Contoso segment 382 and Steve 388 is assigned to the Fabrikam segment 384. A pair of teachers, Tony 390, and Christie 382 teach at Contoso High School and Fabrikam High School, respectively. Therefore, Tony 390 is assigned to a teacher's segment which includes teachers of both high schools, a Contoso segment 382 which includes the teachers and students at Contoso High School and an all staff segment which is assigned to all the staff of Contoso High School. Similarly, the teacher Christie 392 is assigned to a teacher's segment which includes teachers of both high schools. a Fabrikam segment which includes the students and teachers at Fabrikam High School and an all staff segment which includes all staff at Fabrikam High School.

Administrators include Ajay 394 who is an administrator of the computing system for Contoso High School and Farhan 396 who is an administrator of the computer system for Fabrikam High School. Ajay is assigned to the all staff segment for Contoso High School and Farhan is assigned to the all staff segment at Fabrikam High School.

The tenant architecture 380 also shows that Tony 390 started a science fair group 398 on one of the workloads 130-132 so that students at both of the high schools and teachers at both of the high schools, who participate in a science fair, can communicate with one another. Assume now that Tony 390 wishes to add the teacher at Fabrikam, Christie 392, as a moderator of the science fair group 398. Since Tony 390 is the only moderator of the group, and Christie belongs to a common segment as Tony (the “teachers” segment), moderator addition control system 338 generates an output indicating that Christie 392 should be added as a moderator of the science fair group 398. Now assume that Tony 390 requests to add Ora 386 to the group 398. Because Tony 390 is a moderator of the group and Ora and Tony both belong to the “Contoso” segment, member addition control system 336 generates an output indicating that Ora 386 should be added to the science fair group 398.

Now assume that Christie 392 requests to add Steve to the science fair group 398. Because Christie 392 is a moderator of group 398 and both Steve 388 and Christie 392 belong to the “Fabrikam” segment, member addition control system 336 generates an output to indicating that Steve 388 is to be added to the science fair group 398 in response to the request. In the same way, Tony 390 may add Ajay 394 to the science fair group 398 because they both belong to the “all staff” segment for Contoso High School. Similarly, Christie 392 can add Farhan 396 to the science fair group 398 because they both belong to the “all staff” segment for Fabrikam High School.

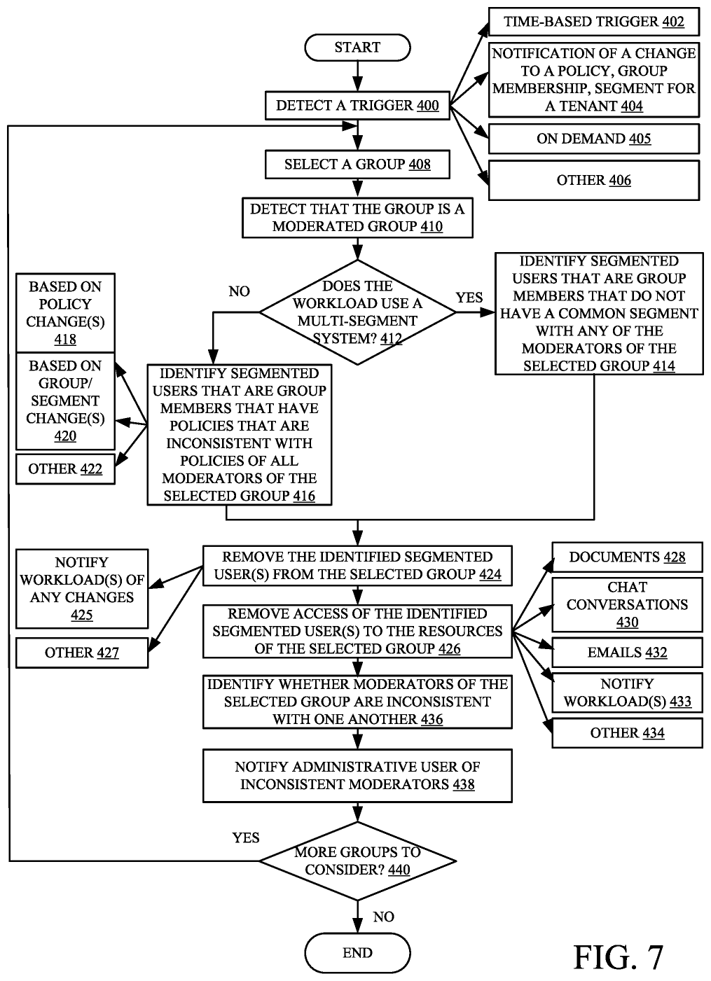

Also, as discussed above, users normally can only add other users to the group that appear or are permitted to appear within the workload. For instance, Steve 388 would not appear in the add dialog of the workload for Tony 390. Also, as discussed above, only the moderators of the science fair group 398 can create and share links to documents or upload documents on the document sharing and collaboration site corresponding to group 398. Also, in one example, non-segmented staff may be added as owners or members of group 398 even in a multi-segment system. If a non-segmented user is added as a moderator of the group, then a user from any segment can join the group because all proposed users will always be compatible with a non-segmented moderator. FIG. 7 is a flow diagram illustrating one example of the operation of retrospective path handler system 322 in response to a change to the computing system, where the change affects who should be allowed to join a group and/or share resources.

It is first assumed that trigger detector 342 detects a trigger indicating that retrospective path handler system 322 should process updates to group membership, policies, segmentation, etc. Detecting a trigger is indicated by block 400 in the flow diagram of FIG. 7. The trigger can be a time-based trigger 402 where system 322 is scheduled to run periodically or otherwise intermittently based on time. The trigger may be a notification of a change to a policy, group membership, or segment for a tenant, as indicated by block 404. In such a case, after a notification is received, or after a predetermined number of notifications are received, this acts as a trigger for system 322 to run. The trigger may be based on an on-demand user input 405, such as when an engineer requests a compliance evaluation instead of waiting for a next scheduled evaluation. The trigger can be detected in a wide variety of other ways as well, as indicated by block 406.

Group selector 343 then selects a group for analysis. Selecting a group can be based upon the change notifications that have been received or based on other criteria. Selecting a group for analysis is indicated by block 408 in the flow diagram of FIG. 7. Group mode identifier 318 identifies the group as being a moderate group. Determining that the group is a moderated group is indicated by block 410 in FIG. 7.

Segment mode identifier 319 also detects whether the workload for the group under analysis is using a multi-segment system, as indicated by block 412. If the workload is a multi-segment workload, then group membership modifier 344 identifies any segmented users that are group members and that do not have a common segment with any of the moderators of the selected group. This is indicated by block 414 in the flow diagram of FIG. 7. Identifying the segments to which a user belongs can be done by analyzing the metadata as discussed above with respect to FIG. 4 and Table 1 or in other ways.

If, at block 412, it is determined that the workload does not use a multi-segment system, then group membership modifier 344 determines whether the group members in the selected group are governed by policies that are consistent with all policies of all of the moderators of the selected group. Any group members with any inconsistent policies are identified by group membership modifier 344. Identifying such segmented users is indicated by block 416 in the flow diagram of FIG. 7. The inconsistencies may be based on policy changes 418 that have been made since retrospective path handler system 322 last ran. The inconsistencies may be based upon group/segment changes 420 that have been made, or other changes 422 that have been made since the last time retrospective path handler 322 ran. For example, if a moderator is removed from a group, then there may be other members of the group that are governed by policies that are inconsistent with the remaining moderators, and those other members need to be removed.

Any segmented users identified at blocks 414 or 416 in FIG. 7 are then removed by group membership modifier 344 from the selected group, as indicated by block 424. Modifier 344 can then notify the workloads 130-132 of any changes, as indicated by block 425, and perform any other desired processing, as by block 427. Resource access modifier 346 then removes access of those identified segmented users to the resources of the selected group, as indicated by block 426. The resources can be documents 428, chat conversations 430, emails 432, or any of a wide variety of other resources 434. Resource access modifier 346 can also notify workloads 130-132 of any access changes indicated by blocks 433.

Group membership modifier 344 also identifies whether the moderators of the selected group are now inconsistent with one another, as indicated by block 436 in the flow diagram of FIG. 7. If the moderators of the selected group are inconsistent with one another (meaning they are governed by policies that are inconsistent with one another or do not have overlapping segments, etc.) then retrospective path handler system 322 notifies the administrative user(s) corresponding to the inconsistent moderators, indicating that the moderators are now inconsistent with one another. Notifying the administrative users is indicated by block 438 in the flow diagram of FIG. 7. Retrospective path handler system 322 then determines whether there are more groups to consider, as indicated by block 440. If so, processing reverts to block 408 where another group is selected for analysis.

Referring again to FIG. 8, some scenarios will be discussed with respect to tenant architecture 380 in order to further illustrate the operation of retrospective path handler system 322. Assume again that user S1 is a member of the group generated by user H1 (who is the moderator of the group). Assume that user S1 now joins the administrative team and is thus assigned to the administrative segment 362. Group membership modifier 344 in retrospective path handler system 322 will then remove user S1 from the group because S1 is now incompatible with user H1. Also, resource access modifier 346 will remove the access of user S1 to any files on the document collaboration and sharing site, and to any other resources for the group.

Now assume that users F1 and I1 are members of the group and H1 is the moderator of the group. Assume also that a segmentation policy has changed so that the human resources segment 360 is no longer allowed to communicate with the finance segment 366. In that case, group membership modifier 344 will remove user F1 from the group.

In addition, it will be noted that retrospective path handler system 322 generates an output indicating to an administrative user when moderators for a group have become inconsistent with one another. This can be done using electronic mail, audit logs, group messaging, etc.

Next assume that users F1 and I1 are members of the group with H1 as the moderator of the group. Now assume that a policy has changed so that the human resources segment 360 is no longer able to communicate or collaborate with the finance segment 364. In that case, any resources associated with the group will no longer be accessible by user F1.

Now referring to FIG. 9, the operation of retrospective path handler system 322 will be further discussed with respect to tenant architecture 380. Assume, for instance, that Ajay 394 has changed his role and is now a lab technician and belongs to a lab technician's segment. In that case, group membership modifier 344 will remove Ajay from the science fair group 398 because the new segment of Ajay does not overlap with any segment of either of the moderators Tony 390 or Christie 392.

Next assume that Christie 392 leaves the teachers position and joins as an administrator. In such a scenario, Steve 388 will be removed from the science fair group 398 because he can no longer be part of a group with Tony 390. Assume next that Farhan 396 has changed his role and is now a health worker and does not belong to any segment. Farhan will be allowed to be part of the science fair group 398 because, as a non-segmented user, he does not need to have an overlapping segment with any of the moderators of the group.

For anyone who has been removed from the science fair group 398, their access to any resources of the group will also be removed as well by resource access modifier 346.

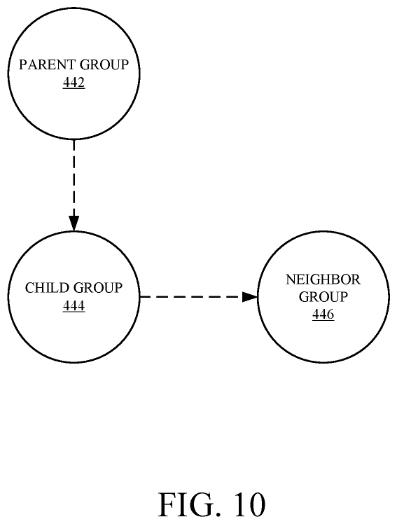

It should be noted that some workloads allow nested groups to be generated. FIG. 10 is a block diagram showing nested groups. Nested groups have a parent-child relationship with members of the parent group 442 having access to the roster and content of a child group 444. In such an example, if the parent group 442 is a moderated group, the child group 444 will inherit that mode. The child group 444 will also inherit the moderators from the parent group 442. The child group 444 may be shared with another neighbor group 446 which can be a parent group of the child group 444, only if the neighbor group 446 is also a moderated group. The live path handler system 320 compares the mode of groups 442 and 446 and, if the modes do not match, disallows sharing of child group 444 with neighbor group 446. If any policy changes are made such as making neighbor group 446 no longer a moderated group, then the groups 444 and 446 are disconnected from one another. Any access to resources that has been shared with neighbor group 446 is also removed.

It can thus be seen that the present description provides a system in which segmented workloads can set up groups as moderated groups that facilitate communication and collaboration of members across group boundaries that would otherwise not be permitted. Requests to add members to a moderated group are analyzed to determine whether the request can be granted or whether it should be rejected. The workload handles granting or rejecting the request based upon the output of the live path handler system 320. If any changes to a group, segment, or policies are made, retrospective path handler system 322 retroactively modifies group membership and modifies access to resources based upon the changes.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one example, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which they are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein. Also, the figures show a number of blocks with functionality ascribed to each block. It will be noted that fewer blocks can be used so the functionality is performed by fewer components. Also, more blocks can be used with the functionality distributed among more components.

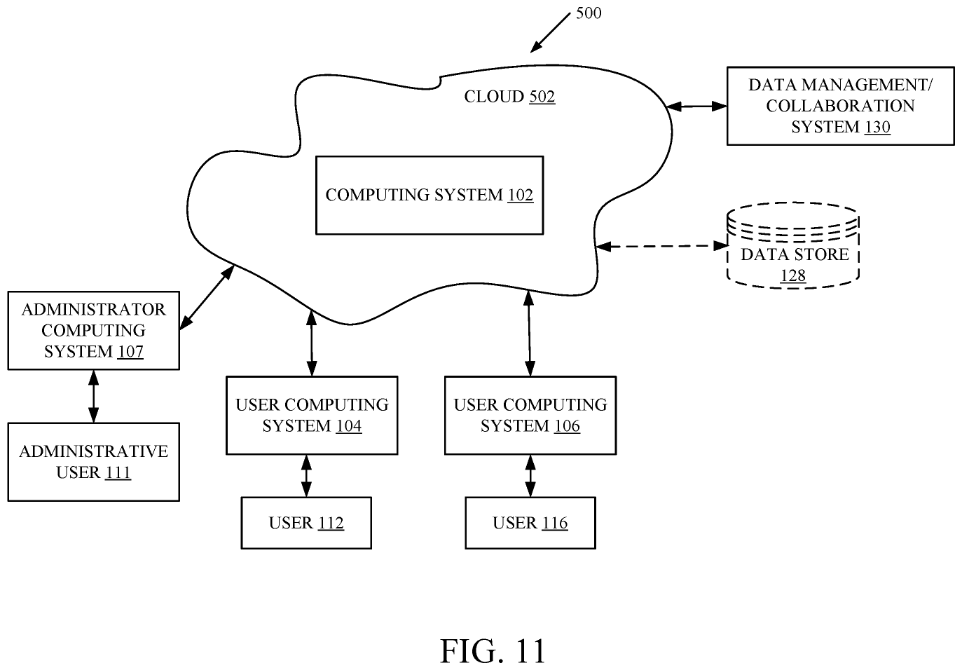

FIG. 11 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 11, some items are similar to those shown in FIG. 1 and they are similarly numbered. FIG. 11 specifically shows that computing system 102 can be located in cloud 502 (which can be public, private, or a combination where portions are public while others are private). Therefore, users 111, and 112-116 use user devices with administrator computing system 107 and user computing systems 104-106, respectively, to access those systems through cloud 502.

FIG. 11 also depicts another example of a cloud architecture. FIG. 11 shows that it is also contemplated that some elements of computing system 102 can be disposed in cloud 502 while others are not. By way of example, data store 128 can be disposed outside of cloud 502, and accessed through cloud 502. In another example, data management/collaboration system 130 (or other items) can be outside of cloud 502. Regardless of where the elements of computing system 102 are located, the elements can be accessed directly by client computing systems 104-107, through a network (either a wide area network or a local area network), the elements can be hosted at a remote site by a service, or the elements can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

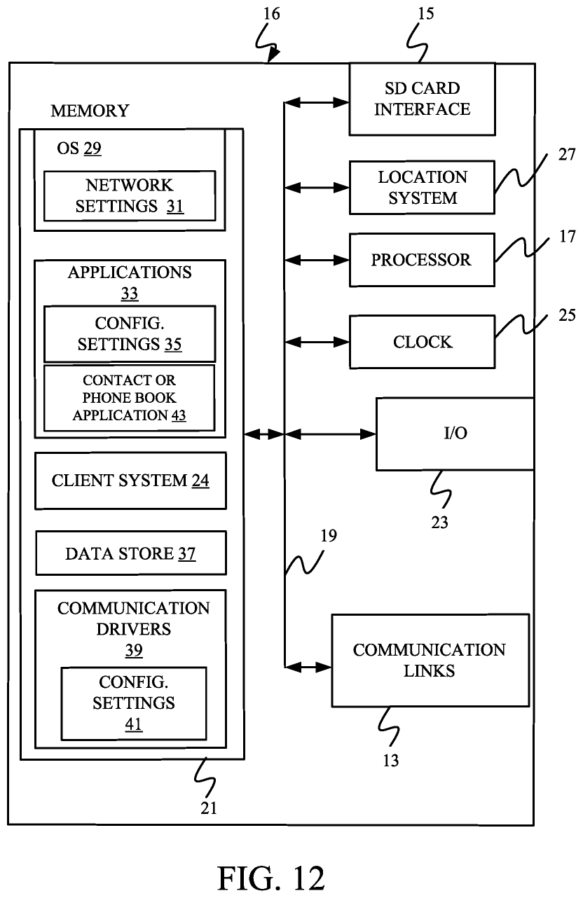

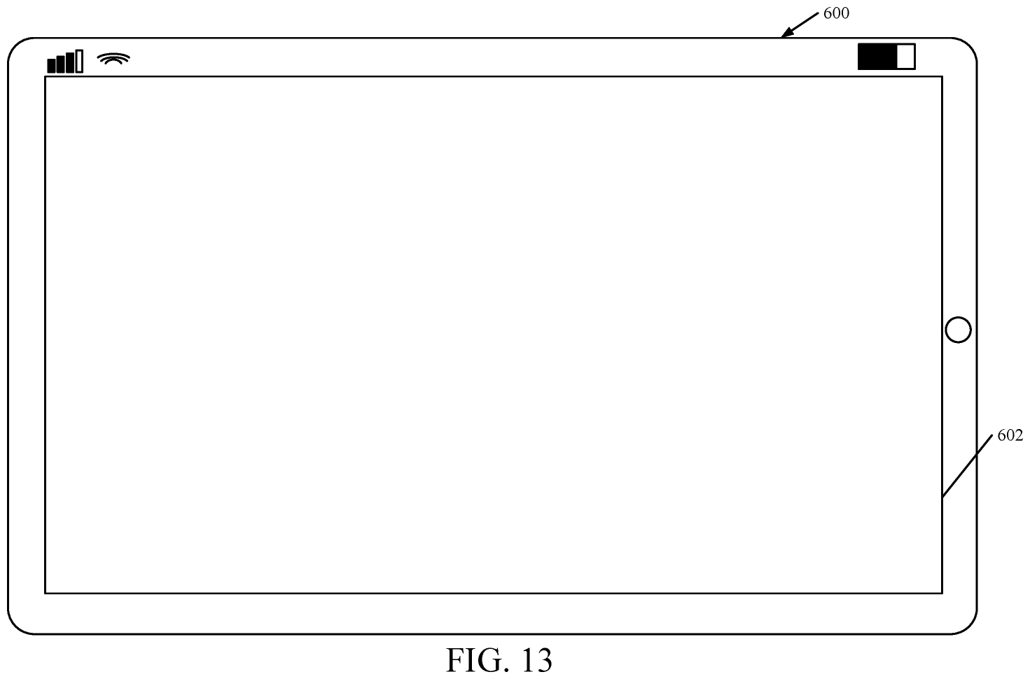

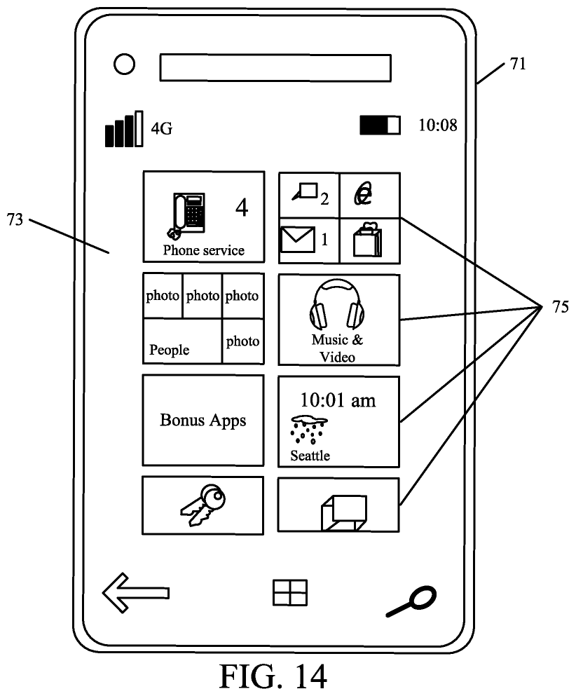

FIG. 12 is a simplified block diagram of one illustrative example of a handheld or mobile computing device that can be used as a user's or client's hand held device 16, in which the present system (or parts of it) can be deployed. FIGS. 13-14 are examples of handheld or mobile devices. FIG. 12 provides a general block diagram of the components of a client device 16 that can run components computing system 102 or user computing systems 104-107 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well. Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 13 shows one example in which device 16 is a tablet computer 600. In FIG. 13, computer 600 is shown with user interface display screen 602. Screen 602 can be a touch screen (so touch gestures from a user's finger can be used to interact with the application) or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 14 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

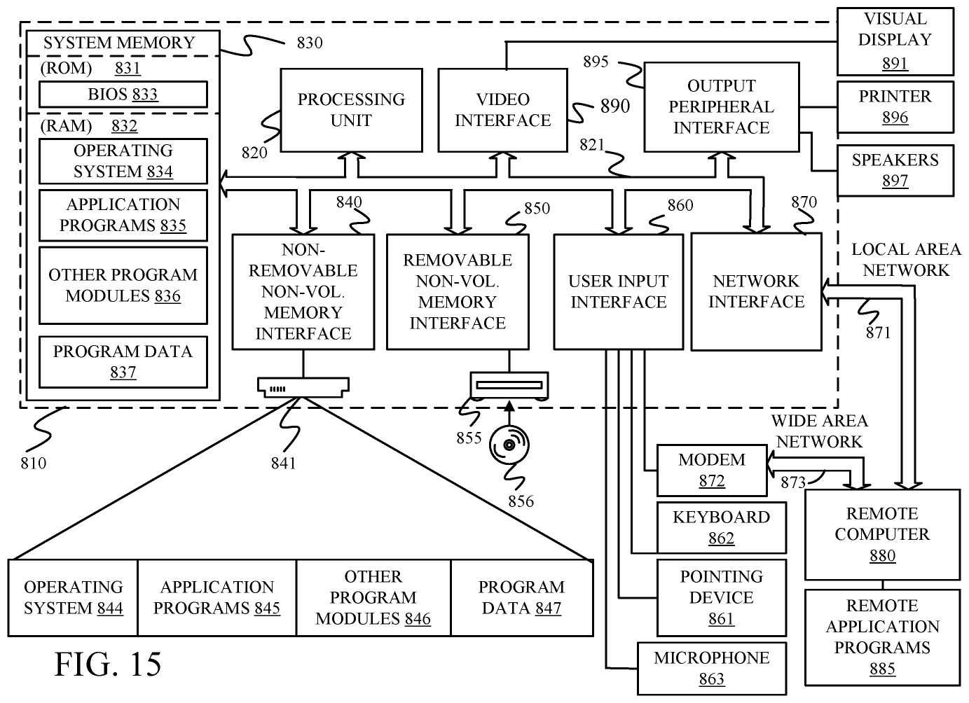

FIG. 15 is one example of a computing environment in which architecture 100, or parts of it, (for example) can be deployed. With reference to FIG. 15, an example system for implementing some embodiments includes a computing device in the form of a computer 810 programmed to operate as discussed above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 15.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 15 illustrates operating system 834, application programs 835, other program modules 836, and program data 837.

The computer 810 may also include other removable/non-removable volatile/nonvolatile computer storage media. By way of example only, FIG. 15 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 15, provide storage of computer readable instructions, data structures, program modules and other data for the computer 810. In FIG. 15, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 15 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 15 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer implemented method, comprising:
receiving a request at a computer system, the computer system being segmented into at least a first segment and a second segment, the first segment having a first policy restricting collaboration between a user assigned to the first segment and a user assigned to the second segment, the computing system configured with a first user assigned to the first segment and a second user assigned to the second segment, the computer system comprising:
a group record corresponding to a selected group of users and including a group mode identifier that identifies whether the selected group is a moderated group and group membership information indicative of users that are members of the corresponding group, the group membership information indicating that the first user is a member of the selected group the request being a request to add the second user to the selected group;
determining that the group mode identifier for the selected group indicates that the selected group is a moderated group; and
generating an output to control membership in the selected group to include the second user based on the group mode identifier identifying the selected group as a moderated group.

Example 2 is the computer implemented method of any or all previous examples wherein generating an output to control membership in the selected group comprises:
identifying a moderator of the selected group.

Example 3 is the computer implemented method of any or all previous examples wherein generating an output to control membership in the selected group comprises:
identifying a policy governing the second user;
identifying a policy governing the moderator of the selected group; and
determining that the policy governing the second user and the policy governing the moderator are consistent with one another.

Example 4 is the computer implemented method of any or all previous examples wherein generating an output to control membership in the selected group comprises:
identifying a segment to which the moderator is assigned; and determining that the moderator and the second user are both assigned to a common segment.

Example 5 is the computer implemented method of any or all previous examples wherein receiving the request comprises:
receiving the request to add the second user as a second moderator of the selected group.

Example 6 is the computer implemented method of any or all previous examples wherein generating an output to control membership in the selected group comprises:
determining whether all moderators of the selected group and the second user are governed by policies that are consistent with one another.

Example 7 is the computer implemented method of any or all previous examples and further comprising:
detecting a trigger to run a retrospective path handler to modify group membership and access to group resources.

Example 8 is the computer implemented method of any or all previous examples and further comprising:
determining whether the selected group is in a workload that uses a multi-segment system in which users can be assigned to a plurality of different segments; and
if so, identifying group members in the selected group that are not assigned to a common segment with any of the moderators of the selected group.

Example 9 is the computer implemented method of any or all previous examples and further comprising:
determining whether the selected group is in a workload that uses a single-segment system in which users can be assigned to a single segment; and
if so, identifying group members in the selected group that are governed by policies that are inconsistent with all moderators of the selected group.

Example 10 is the computer implemented method of any or all previous examples and further comprising:
removing the identified users from the selected group; and
removing access of the identified users to the resources of the selected group.

Example 11 is the computer implemented method of any or all previous examples and further comprising:
identifying that moderators of the selected group are inconsistent with one another; and
generating an output indicative of the inconsistent moderators for surfacing to an administrative user.

Example 12 is a computer system, comprising:
at least one processor;
a data store storing computer executable instructions which, when executed by the at least one processor, cause the at least one processor to perform steps, comprising:
receiving a request at a computer system, the computer system being segmented into at least a first segment and a second segment, the first segment having a first policy restricting collaboration between a user assigned to the first segment and a user assigned to the second segment, the computing system configured with a first user assigned to the first segment and a second user assigned to the second segment, the computer system comprising:
a group record corresponding to a selected group of users and including a group mode identifier that identifies whether the selected group is a moderated group and group membership information indicative of users that are members of the corresponding group, the group membership information indicating that the first user is a member of the selected group, the request being a request to add the second user to the selected group;
determining that the group mode identifier for the selected group indicates that the selected group is a moderated group; and
generating an output to control membership in the selected group to include the second user based on the group mode identifier identifying the selected group as a moderated group.

Example 13 is a computer system, comprising:
a segment management system that segments the computer system into at least a first segment and a second segment, the first segment having a first policy restricting collaboration between a user assigned to the first segment and a user assigned to the second segment, the computing system configured with a first user assigned to the first segment and a second user assigned to the second segment;
a group management system generating a group record corresponding to a selected group of users, the group record including a group mode identifier that identifies whether the selected group is a moderated group and group membership information indicative of users that are members of the selected group, the group membership information indicating that the first user is a member of the selected group;
a change request receiver receiving a request to add the second user to the selected group;
a group mode identification system determining that the group mode identifier for the selected group indicates that the selected group is a moderated group; and
a live path handler system generating an output to control membership in the selected group to include the second user based on the group mode identifier identifying the selected group as a moderated group.

Example 14 is the computer system of any or all previous examples wherein the live path handler system comprises:
a moderator identifier identifying a moderator of the selected group.

Example 15 is the computer system of any or all previous examples wherein the live path handler system comprises:
a member addition control system identifying a policy governing the second user and a policy governing the moderator of the selected group and determining that the policy governing the second user and the policy governing the moderator are consistent with one another.

Example 16 is the computer system of any or all previous examples wherein the live path handler system comprises:
a member addition control system identifying a segment to which the moderator is assigned and determining that the moderator and the second user are both assigned to a common segment.

Example 17 is the computer system of any or all previous examples wherein the change request receiver receives the request to add the second user as a second moderator of the selected group, and wherein the live path handler system is configured to determine whether all moderators of the selected group and the second user are governed by policies that are consistent with one another.

Example 18 is the computer system of any or all previous examples and further comprising a retrospective path handler system configured to detect a trigger to run a retrospective path handler to modify group membership and access to group resources, and further comprising:
a group membership modifier determining whether the selected group is in a workload that uses a multi-segment system in which users can be assigned to a plurality of different segments, and if so, identifying group members in the selected group that are not assigned to a common segment with any of the moderators of the selected group and removing the identified group members from the selected group.

Example 19 is the computer system of any or all previous examples wherein the group membership modifier is further configured to determine whether the selected group is in a workload that uses a single-segment system in which users can be assigned to a single segment, and if so, identifying group members in the selected group that are governed by policies that are inconsistent with all moderators of the selected group and removing the identified group members from the selected group.

Example 20 is the computer system of any or all previous examples and further comprising: a resource access modifier configured to remove access of the identified users to the resources of the selected group.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented method, comprising:
receiving a request at a computer system, the computer system being segmented into at least a first segment and a second segment, the first segment having a first policy restricting collaboration between a user assigned to the first segment and a user assigned to the second segment, the computing system configured with a first user assigned to the first segment and a second user assigned to the second segment, the computer system comprising:
a group record corresponding to a selected group of users and including a group mode identifier that identifies whether the selected group is a moderated group and group membership information indicative of users that are members of the corresponding group, the group membership information indicating that the first user is a member of the selected group, the request being a request to add the second user to the selected group;
determining that the group mode identifier for the selected group indicates that the selected group is a moderated group; and
generating an output to control membership in the selected group to include the second user based on the group mode identifier identifying the selected group as a moderated group.

2. The computer implemented method of claim 1 wherein generating an output to control membership in the selected group comprises:
identifying a moderator of the selected group.

3. The computer implemented method of claim 2 wherein generating an output to control membership in the selected group comprises:
identifying a policy governing the second user;
identifying a policy governing the moderator of the selected group; and
determining that the policy governing the second user and the policy governing the moderator are consistent with one another.

4. The computer implemented method of claim 2 wherein generating an output to control membership in the selected group comprises:
identifying a segment to which the moderator is assigned; and
determining that the moderator and the second user are both assigned to a common segment.

5. The computer implemented method of claim 2 wherein receiving the request comprises:
receiving the request to add the second user as a second moderator of the selected group.

6. The computer implemented method of claim 5 wherein generating an output to control membership in the selected group comprises:
determining whether all moderators of the selected group and the second user are governed by policies that are consistent with one another.

7. The computer implemented method of claim 2 and further comprising:
detecting a trigger to run a retrospective path handler to modify group membership and access to group resources.

8. The computer implemented method of claim 7 and further comprising:
determining whether the selected group is in a workload that uses a multi-segment system in which users can be assigned to a plurality of different segments; and
if so, identifying group members in the selected group that are not assigned to a common segment with any of the moderators of the selected group.

9. The computer implemented method of claim 8 and further comprising:
determining whether the selected group is in a workload that uses a single-segment system in which users can be assigned to a single segment; and
if so, identifying group members in the selected group that are governed by policies that are inconsistent with all moderators of the selected group.

10. The computer implemented method of claim 9 and further comprising:
removing the identified users from the selected group; and
removing access of the identified users to the resources of the selected group.

11. The computer implemented method of claim 10 and further comprising:
identifying that moderators of the selected group are inconsistent with one another; and
generating an output indicative of the inconsistent moderators for surfacing to an administrative user.

12. A computer system, comprising:
at least one processor;
a data store storing computer executable instructions which, when executed by the at least one processor, cause the at least one processor to perform steps, comprising:
receiving a request at a computer system, the computer system being segmented into at least a first segment and a second segment, the first segment having a first policy restricting collaboration between a user assigned to the first segment and a user assigned to the second segment, the computing system configured with a first user assigned to the first segment and a second user assigned to the second segment, the computer system comprising:
a group record corresponding to a selected group of users and including a group mode identifier that identifies whether the selected group is a moderated group and group membership information indicative of users that are members of the corresponding group, the group membership information indicating that the first user is a member of the selected group, the request being a request to add the second user to the selected group;
determining that the group mode identifier for the selected group indicates that the selected group is a moderated group; and
generating an output to control membership in the selected group to include the second user based on the group mode identifier identifying the selected group as a moderated group.

13. A computer system, comprising:
a segment management system that segments the computer system into at least a first segment and a second segment, the first segment having a first policy restricting collaboration between a user assigned to the first segment and a user assigned to the second segment, the computing system configured with a first user assigned to the first segment and a second user assigned to the second segment;
a group management system generating a group record corresponding to a selected group of users, the group record including a group mode identifier that identifies whether the selected group is a moderated group and group membership information indicative of users that are members of the selected group, the group membership information indicating that the first user is a member of the selected group;
a change request receiver receiving a request to add the second user to the selected group;
a group mode identification system determining that the group mode identifier for the selected group indicates that the selected group is a moderated group; and
a live path handler system generating an output to control membership in the selected group to include the second user based on the group mode identifier identifying the selected group as a moderated group.

14. The computer system of claim 12 wherein the live path handler system comprises:
a moderator identifier identifying a moderator of the selected group.

15. The computer system of claim 14 wherein the live path handler system comprises:
a member addition control system identifying a policy governing the second user and a policy governing the moderator of the selected group and determining that the policy governing the second user and the policy governing the moderator are consistent with one another.
